(19) United States
(12) Patent Application Publication
(10) Pub. No.: US 2024/0046140 A1
(43) Pub. Date: Feb. 8, 2024

(54) SIMULATION METHOD, ELECTRONIC DEVICE, AND STORAGE MEDIUM

(71) Applicant: Beijing Baidu Netcom Science Technology Co., Ltd., Beijing (CN)

(72) Inventors: Yuxuan WANG, Beijing (CN); Lijing JIN, Beijing (CN)

(21) Appl. No.: 18/193,916

(22) Filed: Mar. 31, 2023

(30) Foreign Application Priority Data
Aug. 4, 2022 (CN) 202210934651.2

(51) Int. Cl. G06N 10/80; G06N 10/20

(52) U.S. Cl. CPC G06N 10/80; G06N 10/20

(57) ABSTRACT

Provided is a simulation method, electronic device, and storage medium relating to the field quantum computers and quantum simulation. The simulation method can include obtaining a first normal mode frequency of a first target device with adjustable frequency among at least two devices of a quantum chip layout through simulation; determining resonance-related information of the first target device and a second target device in a resonant state among the at least two devices; where the second target device is a device with adjustable or non-adjustable frequency among the at least two devices; and obtaining a target coupling strength between the first and second target devices based on the first normal mode frequency of the first target device and the resonance-related information.

### CROSS-REFERENCE TO RELATED APPLICATIONS

The present application claims priority to Chinese Patent Application No. 202210934651.2, filed with the China National Intellectual Property Administration on Aug. 4, 2022, the disclosure of which is hereby incorporated herein by reference in its entirety.

### TECHNICAL FIELD

The present disclosure relates to the field of computing, in particular to the field of quantum computers and quantum simulation.

### BACKGROUND

In the entire layout design of a quantum chip, the design of characteristic parameters is an important part. For example, the design of coupling strength between different devices is a top priority. Therefore, there is an urgent need for a solution to conveniently obtain the coupling strength between target devices in a quantum chip layout.

### SUMMARY

The present disclosure provides a simulation method, apparatus, device and storage medium.

According to an aspect of the present disclosure, provided is a simulation method, including: obtaining a first normal mode frequency of a first target device with adjustable frequency among at least two devices of a quantum chip layout through simulation; determining resonance-related information of the first target device and a second target device in a resonant state among the at least two devices; where the second target device is a device with adjustable or non-adjustable frequency among the at least two devices; and obtaining a target coupling strength between the first and second target devices based on the first normal mode frequency of the first target device and the resonance- related information.

According to another aspect of the present disclosure, provided is a simulation apparatus, including: a first determining unit configured to obtain a first normal mode frequency of a first target device with adjustable frequency among at least two devices of a quantum chip layout through simulation; a second determining unit configured to determine resonance-related information of the first target device and a second target device in a resonant state among the at least two devices; where the second target device is a device with adjustable or non-adjustable frequency among the at least two devices; and a data processing unit configured to obtain a target coupling strength between the first and second target devices based on the first normal mode frequency of the first target device and the resonance-related information.

According to yet another aspect of the present disclosure, provided is an electronic device, including: at least one processor; and a memory connected in communication with the at least one processor; where the memory stores an instruction executable by the at least one processor, and the instruction, when executed by the at least one processor, enables the at least one processor to execute the method of any of the embodiments of the present disclosure.

According to yet another aspect of the present disclosure, provided is a non-transitory computer-readable storage medium storing a computer instruction thereon, and the computer instruction causes a computer to execute the method of any of the embodiments of the present disclosure.

According to yet another aspect of the present disclosure, provided is a computer program product including a computer program, and the computer program implements the method of any of the embodiments of the present disclosure, when executed by a processor.

Thus, the solution of the present disclosure can effectively determine the coupling strength between two target devices in the quantum chip layout and is applicable to any complex device that is difficult to model in most quantum chips, and the simulation overhead is relatively small, and the practicality and applicability are both strong.

It will be understood that this summary is not intended to identify key or important features of any of the embodiments of the present disclosure, nor does it limit the scope of the present disclosure. Other features of the present disclosure will be easily understood by the following detailed description.

### BRIEF DESCRIPTION OF THE DRAWINGS

The accompanying drawings are used to better understand the present solution, and do not constitute a limitation to the present disclosure.

FIG. 1 is a first schematic diagram of an implementation flow of a simulation method according to an embodiment of the present disclosure.

FIG. 2 is a second schematic diagram of an implementation flow of a simulation method according to an embodiment of the present disclosure.

FIG. 3 is a third schematic diagram of an implementation flow of a simulation method according to an embodiment of the present disclosure.

FIG. 4 is a schematic diagram of an implementation flow of a simulation method in a specific example according to an embodiment of the present disclosure.

FIG. 5 is a schematic structural diagram of a quantum chip layout in a specific example according to an embodiment of the present disclosure.

FIG. 6 is a schematic diagram of a resonance sweep curve of a qubit (quantum bit) and a read resonant cavity obtained by simulating the quantum chip layout shown in FIG. 5 in a specific example according to an embodiment of the present disclosure.

FIG. 7 is a diagram of result comparison of the coupling strength between the qubit and the read cavity obtained by the simulation method according to the embodiments of the present disclosure and other simulation methods.

FIG. 8 is a schematic structural diagram of a simulation apparatus according to an embodiment of the present disclosure.

FIG. 9 is a block diagram of an electronic device used to implement the simulation method of the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

As the limit of Moore's Law under classical computing power is gradually being approached, quantum computing is considered to be a breakthrough and innovative computing technology in the future, and is expected to solve many problems that are difficult to be processed by classical computing. In order for the quantum computing to reach its true potential and to be actually implemented, the implementation of quantum algorithms and quantum applications cannot be separated from the support of the underlying quantum hardware. Superconducting quantum systems are considered to be among the best candidates for quantum computing hardware implementation due to good scalability and manipulability. As the physical realization of a superconducting quantum system, design, development and fabrication of a superconducting quantum chip integrating a plurality of superconducting qubits (quantum bits) are of great significance.

In the design of the superconducting quantum chip, how to precisely and efficiently determine the coupling strength between devices in the layout of the superconducting quantum chip is particularly important. In terms of precision, the coupling strength between devices affects the performance of the entire quantum chip, such as the crosstalk of qubits, the speed of implementing quantum gates, etc.; and in terms of efficiency, the coupling strength between devices affects the length of a complete research and development cycle of “design, verification and iteration” of the entire quantum chip.

Based on this, the solution of the present disclosure proposes a solution for precisely solving the coupling strength between two target devices in a quantum chip layout (such as superconducting quantum chip layout).

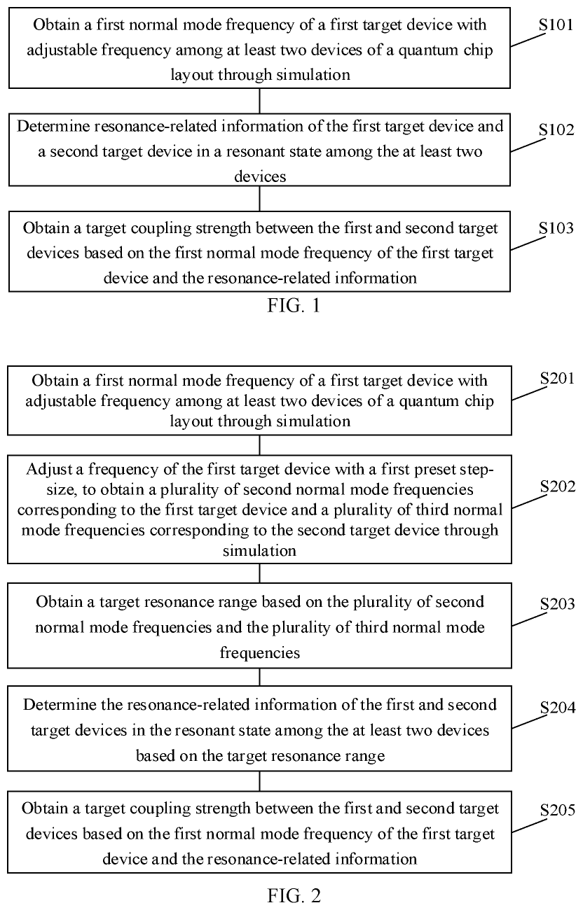

Specifically, FIG. 1 is a first schematic diagram of an implementation flow of a simulation method according to an embodiment of the present disclosure. This method may optionally be applied to a classical computing device, such as a personal computer, a server, a server cluster, and any other electronic device with classical computing capability. Further, this method includes at least a part of the following content. Specifically, as shown in FIG. 1, this method includes the following steps.

In step S101, a first normal mode frequency of a first target device with adjustable frequency among at least two devices of a quantum chip layout is obtained through simulation.

It should be noted that the quantum chip layout described in the solution of the present disclosure can describe the geometric shapes of the physical structures in the real quantum chip (or superconducting quantum chip), including but not limited to the shape, area and position of each physical structure on the quantum chip, etc. For example, the quantum chip layout describes the positions of various devices such as qubits, coupling devices and read resonant cavities, and the connection relationship thereof, etc.

In step S102, the resonance-related information of the first target device and a second target device in a resonant state among the at least two devices is determined; where the second target device is a device with adjustable or non-adjustable frequency among the at least two devices.

In step S103, a target coupling strength between the first and second target devices is obtained based on the first normal mode frequency of the first target device and the resonance-related information.

In this way, the solution of the present disclosure can conveniently obtain the target coupling strength between the target devices (such as the first target device and the second target device) in the quantum chip layout without complex modeling of the quantum chip layout, is not limited by the scale of the quantum chip layout, and is applicable to any complex device that is difficult to model in most quantum chips; and the simulation overhead is relatively small, and the practicality and applicability are both strong.

Further, since the solution of the present disclosure can conveniently obtain the target coupling strength between the target devices in the quantum chip layout without complex modeling of the quantum chip layout, it is more applicable to the scene where there are a large number of qubits in the quantum chip layout.

In a specific example, the target coupling strength obtained by the solution of the present disclosure is the coupling strength between the first and second target devices in the non-resonant state, so the solution of the present disclosure is more general and universal.

In a specific example, the quantum chip layout may also specifically be a layout of a superconducting quantum chip. Here, the superconducting quantum chip refers to a quantum chip made of superconducting materials. For example, all components (such as qubits, coupling devices, etc.) in the superconducting quantum chip are made of superconducting materials.

Further, when the solution of the present disclosure is applied to the superconducting quantum chip layout, the solution of the present disclosure can also be applicable to any complex device that is difficult to model in most superconducting quantum chips, and similarly, the simulation overhead is small.

It should be noted that the first and second target devices described in the solution of the present disclosure are any two devices that have a coupling relationship in the quantum chip layout; and further, in a specific example, the first target device is a device with adjustable frequency, such as a qubit or coupler. In another specific example, the second target device is a device with adjustable frequency, such as a qubit or coupler, or a device with non-adjustable frequency, such as a read resonant cavity, filter, read transmission line or control line. Based on this, the solution of the present disclosure can determine the coupling strength between one device with adjustable frequency and another device with non-adjustable frequency in the quantum chip layout, and can also determine the coupling strength between one device with adjustable frequency and another device with adjustable frequency in the quantum chip layout.

In a specific example of the solution of the present disclosure, the first normal mode frequency is a normal mode frequency of the first target device in the non-resonant state. Further, the first normal mode frequency is the normal mode frequency of the first target device in the non-resonant state when the frequency is a first frequency value (such as an initial frequency value). Alternatively, the first normal mode frequency is a normal mode frequency of the first target device in the resonant state; and further, the first normal mode frequency is the normal mode frequency of the first target device in the resonant state when the frequency is a first frequency value (such as an initial frequency value). In this way, the foundation is laid for the subsequent simulation to obtain the coupling strength of two target devices in the quantum chip layout, and especially the coupling strength of two target devices in the non-resonant state.

In a specific example of the solution of the present disclosure, a simulation method is further provided. FIG. 2 is a second schematic flowchart of the simulation method according to an embodiment of the present application. This method may optionally be applied to a classical computing device, such as a personal computer, a server, a server cluster, and other electronic device with classical computing capability. It can be understood that the relevant content of the method shown in FIG. 1 described above may also be applied to this example, and the relevant content will not be repeated in this example.

Further, this method includes at least a part of the following content. Specifically, as shown in FIG. 2, this method includes the following steps.

In step S201, a first normal mode frequency of a first target device with adjustable frequency among at least two devices of a quantum chip layout is obtained through simulation.

Here, for the related description of the first normal mode frequency, reference may be made to the above description, which will not be repeated here.

In step S202, a frequency of the first target device is adjusted with a first preset step-size, and a plurality of second normal mode frequencies corresponding to the first target device and a plurality of third normal mode frequencies corresponding to the second target device are obtained through simulation; where the plurality of second normal mode frequencies are normal mode frequencies corresponding to the first target device when the first target device is at a plurality of frequency values determined based on the first preset step-size, and the plurality of third normal mode frequencies are normal mode frequencies corresponding to the second target device when the first target device is at the plurality of frequency values obtained based on the first preset step-size.

Here, in this example, the second target device is a device with adjustable or non-adjustable frequency among the at least two devices.

It should be noted that the frequency of the second target device is a fixed value when the second target device is a device with adjustable frequency in this example. In other words, there is only a need in this example to adjust the frequency of the first target device multiple times, that is, sweep the frequency of the first target device, to obtain the plurality of second normal mode frequencies and the plurality of third normal mode frequencies, without adjusting the frequency of the second target device.

It should be noted that, when the frequency value of the first target device is determined, one second normal mode frequency corresponding to the first target device and one third normal mode frequency corresponding to the second target device can be obtained through simulation; and further, during adjusting the frequency value of the first target device, one second normal mode frequency corresponding to the first target device and one third normal mode frequency corresponding to the second target device can be obtained through re-simulation each time the adjustment is made. In this way, after the adjustment is made multiple times, the plurality of second normal mode frequencies and the plurality of third normal mode frequencies corresponding to the plurality of frequency values can be obtained.

Here, when the frequency value of the first target device is determined, the second normal mode frequency and the third normal mode frequency corresponding to the frequency value may be obtained in one simulation process or in different simulation processes. For example, at this frequency value, the second normal mode frequency is obtained in one simulation process; and at this frequency value, the third normal mode frequency is obtained in another simulation process, etc., which is not limited in the solution of the present disclosure. All cases are within the protection scope of the solution of the present disclosure as long as the plurality of second normal mode frequencies and the plurality of third normal mode frequencies corresponding to the plurality of frequency values can be obtained.

In a specific example of the solution of the present disclosure, the frequency of the first target device may also be adjusted in the following manner; specifically, the step of adjusting the frequency of the first target device described above may specifically include: adjusting the frequency of the first target device by adjusting the equivalent inductance of the first target device.

In a specific example, the adjustment may specifically be increase or decrease. The purpose of the adjustment is to make the normal mode frequencies of two target devices (that is, the first target device and the second target device) as close as possible, so that it is convenient to find a frequency range (that is, a target frequency range) in which the two target devices (that is, the first target device and the second target device) reach the resonant state.

In this way, the solution of the present disclosure provides a simple and feasible power adjustment manner, thus providing feasible technical support for the subsequent simulation to obtain the coupling strength of two target devices in the quantum chip layout, and especially the coupling strength of two target devices in the non-resonant state.

In another specific example, the first preset step-size may specifically refer to a first preset inductance step-size. At this time, the equivalent inductance of the first target device may be adjusted with the first preset step-size (that is, the first preset inductance step-size), to thereby achieve the purpose of adjusting the frequency of the first target device. In this way, the adjustment of the equivalent inductance makes the normal mode frequencies of two target devices (that is, the first target device and the second target device) as close as possible, to find the frequency range (that is, the target frequency range) in which the two target devices (that is, the first target device and the second target device) reach the resonant state.

Specifically, the equivalent inductance of the first target device is adjusted from a first value to a second value with the first preset step-size, thereby realizing the adjustment of the first target device from a first frequency value to a second frequency value; and further, the second normal mode frequency corresponding to the first target device and the third normal mode frequency corresponding to the second target device when the first target device is at the second frequency value are obtained through simulation, thus completing one rough frequency adjustment.

Here, in a specific example, the first value corresponds to the first normal mode frequency, that is, the first normal mode frequency is the normal mode frequency when the equivalent inductance of the first target device is the first value.

Further, continuing to take the first preset step-size being the first preset inductance step-size as an example, the equivalent inductance of the first target device may further be adjusted from the second value to the third value at this time, thereby realizing the adjustment of the first target device from the second frequency value to a third frequency value; and further, the second normal mode frequency corresponding to the first target device and the third normal mode frequency corresponding to the second target device when the first target device is at the third frequency value are obtained through simulation, thus completing two rough frequency adjustments.

By analogy, the plurality of second normal mode frequencies corresponding to the first target device and the plurality of third normal mode frequencies corresponding to the second target device when the first target device is at the plurality of frequency values determined based on the first preset step-size are obtained.

It should be noted that, after each adjustment of the equivalent inductance of the first target device, the first and second target devices may be simulated at the same time, to simultaneously obtain the second normal mode frequency and the third normal mode frequency under one inductance value (that is, the frequency value corresponding to the inductance value); or, the first and second target devices may be simulated respectively, and the second normal mode frequency and the third normal mode frequency under one inductance value (that is, the frequency value corresponding to the inductance value) are obtained through two simulations, which is not limited in the solution of the present disclosure.

Furthermore, it is worth noting that, if the above-mentioned first preset step-size is the first preset inductance step-size, the absolute value of the difference between the second value and the first value, and the absolute value of the difference between the third value and the second value, etc. are all the first preset inductance step-size; and further, the above-mentioned first preset step-size may also be a preset frequency step-size, that is, a first preset frequency step-size. At this time, the absolute value of the difference between the second frequency value and the first frequency value, and the absolute value of the difference between the third frequency value and the second frequency value, etc. are all the first preset frequency step-size.

It should be noted that the solution of the present disclosure does not specifically limit whether the first preset step-size is a frequency step-size or an inductance step-size. Both cases are within the protection scope of the solution of the present disclosure as long as the frequency range (that is, the target frequency range) in which the two target devices (that is, the first target device and the second target device) reach the resonant state can be found by adjusting the frequency of the first target device.

In step S203, a target resonance range is obtained based on the plurality of second normal mode frequencies and the plurality of third normal mode frequencies.

In a specific example, the target resonance range is a frequency range determined based on the plurality of second normal mode frequencies and the plurality of third normal mode frequencies; for example, the maximum frequency value among the plurality of second normal mode frequencies and the plurality of third normal mode frequencies is used as the upper limit of the target resonance range, and the minimum frequency value among the plurality of second normal mode frequencies and the plurality of third normal mode frequencies is used as the lower limit of the target resonance range, to thereby obtain the target resonance range.

Further, in the case where the frequency of the first target device is adjusted by adjusting the equivalent inductance of the first target device, the target resonance range may also specifically be an inductance value range of the equivalent inductance, or the like. For example, the maximum inductance value corresponding to the plurality of second normal mode frequencies or the plurality of third normal mode frequencies is used as the upper limit of the target resonance range, and the minimum inductance value corresponding to the plurality of second normal mode frequencies or the plurality of third normal mode frequencies is used as the lower limit of the target resonance range, to thereby obtain the target resonance range.

It should be noted that the solution of the present disclosure does not specifically limit the data expression form of the target resonance range, as long as the resonance-related information of the first and second target devices in the resonant state can be determined based on the target resonance range.

In step S204, the resonance-related information of the first and second target devices in the resonant state among the at least two devices is determined based on the target resonance range.

In a specific example, the resonance-related information includes at least one of: a target resonance frequency at which the first and second target devices are in the resonant state; and a resonance coupling strength of the first and second target devices in the resonant state.

In step S205, a target coupling strength between the first and second target devices is obtained based on the first normal mode frequency of the first target device and the resonance-related information.

In this way, the solution of the present disclosure obtains the target resonance range through rough frequency sweep (or rough simulation), and then uses the target resonance range to obtain the resonance-related information of the first and second target devices in the resonant state, thus improving the simulation efficiency, also saving the time and computing resources occupied by electromagnetic simulation, and then quickly obtaining the coupling strength between two target devices in the quantum chip layout through simulation.

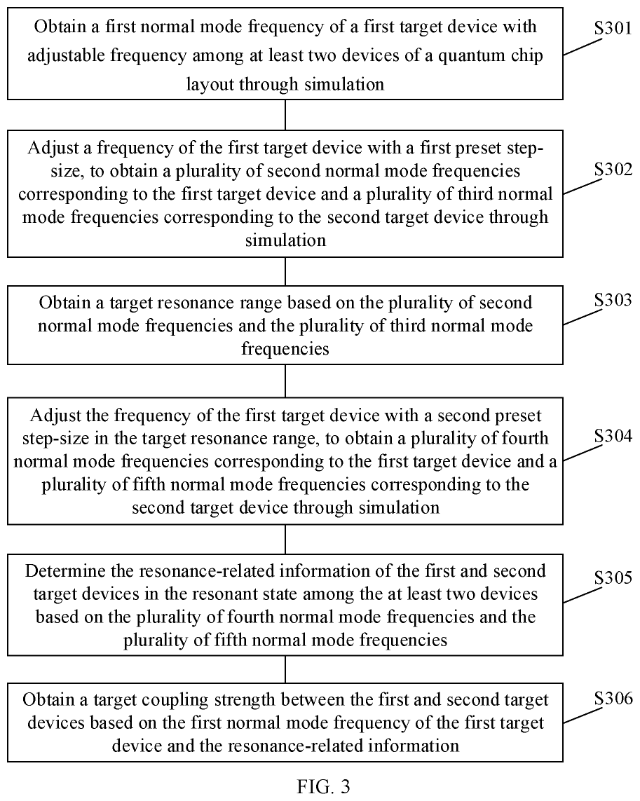

In a specific example of the solution of the present disclosure, a simulation method is further provided. FIG. 3 is a third schematic flowchart of the simulation method according to an embodiment of the present application. This method may optionally be applied to a classical computing device, such as a personal computer, a server, a server cluster, and other electronic device with classical computing capability. It can be understood that the relevant content of the method shown in FIG. 1 and FIG. 2 described above may also be applied to this example, and the relevant content will not be repeated in this example.

Further, this method includes at least a part of the following content. Specifically, as shown in FIG. 3, this method includes the following steps.

In step S301, a first normal mode frequency of a first target device with adjustable frequency among at least two devices of a quantum chip layout is obtained through simulation.

In step S302, a frequency of the first target device is adjusted with a first preset step-size, and a plurality of second normal mode frequencies corresponding to the first target device and a plurality of third normal mode frequencies corresponding to the second target device are obtained through simulation; where the plurality of second normal mode frequencies are normal mode frequencies corresponding to the first target device when the first target device is at a plurality of frequency values determined based on the first preset step-size, and the plurality of third normal mode frequencies are normal mode frequencies corresponding to the second target device when the first target device is at a plurality of frequency values obtained based on the first preset step-size.

Here, in this example, the second target device is a device with adjustable or non-adjustable frequency among the at least two devices. It can be understood that the relevant description of the second target device can refer to the above content, which will not be repeated here.

In step S303, a target resonance range is obtained based on the plurality of second normal mode frequencies and the plurality of third normal mode frequencies.

It can be understood that the relevant content of the above rough frequency sweep can refer to the relevant description of the method shown in FIG. 2, which will not be repeated here.

In step S304, the frequency of the first target device is adjusted with a second preset step-size in the target resonance range, and a plurality of fourth normal mode frequencies corresponding to the first target device and a plurality of fifth normal mode frequencies corresponding to the second target device are obtained through simulation; where the plurality of fourth normal mode frequencies are normal mode frequencies corresponding to the first target device when the first target device is at a plurality of frequency values determined based on the second preset step-size; and the plurality of fifth normal mode frequencies are normal mode frequencies corresponding to the second target device when the first target device is at a plurality of frequency values determined based on the second preset step-size.

It can be understood that the first preset step-size is an interval set for the rough frequency sweep, for the purpose of obtaining the target resonance range; and the second preset step-size is an interval set for the precise frequency sweep, for the purpose of finding the resonant state of the first and second target devices. Based on this, in order to improve the precision, the second preset step-size is smaller than the first preset step-size.

It can be understood that, similar to the first preset step-size, the second preset step-size may also specifically refer to a second preset inductance step-size. At this time, the equivalent inductance of the first target device may be adjusted with the second preset inductance step-size, thereby achieving the purpose of adjusting the frequency of the first target device. Alternatively, the second preset step-size may also be a preset frequency step-size, that is, a second preset frequency step-size.

In this way, the target resonance range is obtained through the rough frequency sweep, and then the resonance-related information is obtained by using the target resonance range obtained by the rough frequency sweep. Further, the specific steps of performing the precise frequency sweep (also referred to as precise simulation) in the target resonance range and obtaining the resonance-related information will be described below.

In a specific example, the adjustment of the frequency of the first target device is achieved by adjusting the equivalent inductance of the first target device.

In a specific example, the adjustment may specifically be increase or decrease. The purpose of the adjustment is to make the normal mode frequencies of two target devices (that is, the first target device and the second target device) as close as possible, so that it is convenient to find a frequency range (that is, a target frequency range) in which the two target devices (that is, the first target device and the second target device) reach the resonant state.

Further, in an example, during the rough frequency sweep, the equivalent inductance of the first target device is adjusted with the first preset step-size, to thereby adjust the frequency of the first target device. The detailed description can refer to the relevant content of the method shown in FIG. 2, which will not be repeated here.

Further, in another example, during the precise frequency sweep, the equivalent inductance of the first target device is adjusted with the second preset step-size within the target resonance range, to thereby adjust the frequency of the first target device; specifically, the equivalent inductance of the first target device is adjusted from a fifth value to a sixth value with the second preset step-size within the target resonance range, thereby realizing the adjustment of the first target device from a fifth frequency value to a sixth frequency value; and further, the fourth normal mode frequency corresponding to the first target device and the fifth normal mode frequency corresponding to the second target device when the first target device is at the sixth frequency value are obtained through simulation, thus completing one precise frequency adjustment.

Further, the equivalent inductance of the first target device continues to be adjusted from the sixth value to a seventh value with the second preset step-size, thereby realizing the adjustment of the first target device from the sixth frequency value to a seventh frequency value; and further, the fourth normal mode frequency corresponding to the first target device and the fifth normal mode frequency corresponding to the second target device when the first target device is at the seventh frequency value are obtained through simulation, thus completing two precise frequency adjustments.

By analogy, a plurality of fourth normal mode frequencies corresponding to the first target device and a plurality of fifth normal mode frequencies corresponding to the second target device when the first target device is at a plurality of frequency values determined based on the second preset step-size are obtained.

It should be noted that, after each adjustment of the equivalent inductance of the first target device, the first and second target devices may be simulated at the same time, to simultaneously obtain the fourth normal mode frequency and the fifth normal mode frequency under one inductance value (that is, the frequency value corresponding to the inductance value); or, the first and second target devices may be simulated respectively, and the fourth normal mode frequency and the fifth normal mode frequency under one inductance value (that is, the frequency value corresponding to the inductance value) are obtained through two simulations, which is not limited in the solution of the present disclosure.

Furthermore, it is worth noting that, if the above-mentioned second preset step-size is the second preset inductance step-size, the absolute value of the difference between the fifth value and the sixth value, and the absolute value of the difference between the sixth value and the seventh value, etc. are all the second preset inductance step-size; and further, the above-mentioned second preset step-size may also be a preset frequency step-size, that is, a second preset frequency step-size. At this time, the absolute value of the difference between the fifth frequency value and the sixth frequency value, the absolute value of the difference between the sixth frequency value and the seventh frequency value, etc. are all the second preset frequency step-size.

It should be noted that the solution of the present disclosure does not specifically limit whether the second preset step-size is a frequency step-size or an inductance step-size. Both cases are within the protection scope of the solution of the present disclosure as long as the resonance-related information can be found by adjusting the frequency of the first target device.

In this way, the solution of the present disclosure provides a simple and feasible power adjustment manner, thus laying the foundation for the subsequent simulation to obtain the coupling strength of two target devices in the quantum chip layout, and especially the coupling strength of two target devices in the non-resonant state.

In step S305, the resonance-related information of the first and second target devices in the resonant state among the at least two devices is determined based on the plurality of fourth normal mode frequencies and the plurality of fifth normal mode frequencies.

In a specific example, the resonance-related information includes at least one of: a target resonance frequency at which the first and second target devices are in the resonant state; and a resonance coupling strength of the first and second target devices in the resonant state.

In step S306, a target coupling strength between the first and second target devices is obtained based on the first normal mode frequency of the first target device and the resonance-related information.

In this way, the solution of the present disclosure obtains the target resonance range through rough frequency sweep (or rough simulation) and then conducts the precise frequency sweep based on the target resonance range, to obtain the resonance-related information of the first and second target devices in the resonant state and then obtain the target coupling strength between the first and second target devices, thus improving the simulation efficiency, and also saving the time and computing resources occupied by electromagnetic simulation, and then quickly obtaining the coupling strength between two target devices in the quantum chip layout through simulation. Also, the prediction result is more precise and has certain robustness to simulation errors.

In a specific example of the solution of the present disclosure, after the plurality of fourth normal mode frequencies and the plurality of fifth normal mode frequencies are obtained by the precise frequency sweep, the resonance-related information is further obtained in the following way; and specifically, the above-mentioned step of determining the resonance-related information of the first and second target devices in the resonant state among the at least two devices based on the plurality of fourth normal mode frequencies and the plurality of fifth normal mode frequencies includes: obtaining a target frequency interval based on frequency intervals (i.e., frequency differences) between the fourth normal mode frequencies and the fifth normal mode frequencies corresponding to the frequency values; and obtaining the resonance-related information of the first and second target devices in the resonant state containing a resonance coupling strength and/or a target resonance frequency, based on the target frequency interval.

That is to say, in this example, the resonance coupling strength of the first and second target devices in the resonant state can be obtained based on the target frequency interval, for example, the resonance coupling strength g₀=the target frequency interval/2.

Further, the target resonance frequency at which the first and second target devices are in the resonant state may also be obtained based on the target frequency interval, and may be obtained in the following ways.

In a first way, the target resonance frequency at which the first and second target devices are in the resonant state is obtained based on the target frequency interval and the normal mode frequency at which the first target device is in the resonant state; for example, the target resonance frequency ω₀=the fourth normal mode frequency corresponding to the target frequency interval−/+the target frequency interval/2.

In a second way, the target resonance frequency at which the first and second target devices are in the resonant state is obtained based on the target frequency interval and the normal mode frequency at which the second target device is in the resonant state; for example, the target resonance frequency ω₀=the fifth normal mode frequency corresponding to the target frequency interval+/−the target frequency interval/2.

In a third way, the target resonance frequency at which the first and second target devices are in the resonant state is obtained based on the normal mode frequency at which the first target device is in the resonant state and the normal mode frequency at which the second target device is in the resonant state; for example, the target resonance frequency=(the fourth normal mode frequency corresponding to the target frequency interval+the fifth normal mode frequency corresponding to the target frequency interval)/2.

It should be noted that one of the three ways described above may be selected and implemented in practical applications, which is not limited in the solution of the present disclosure.

In this way, the solution of the present disclosure provides a specific way to obtain the resonance-related information through the precise frequency sweep, and the simulation efficiency is high, the fewer computing resources are occupied, and the prediction result is more precise, while also having certain robustness to simulation errors.

In a specific example of the solution of the present disclosure, the above-mentioned step of obtaining the target frequency interval based on the frequency intervals between the fourth normal mode frequencies and the fifth normal mode frequencies corresponding to the frequency values may specifically include: obtaining a minimum frequency interval based on a frequency interval between a fourth normal mode frequency and a corresponding fifth normal mode frequency corresponding to each frequency value; and taking the minimum frequency interval as the target frequency interval.

It can be understood that, in this example, one frequency value corresponds to one fourth normal mode frequency and one fifth normal mode frequency, and then corresponds to one frequency interval; and further, a plurality of frequency values correspond to a plurality of frequency intervals. At this time, the minimum frequency interval among the plurality of frequency intervals is taken as the target frequency interval, and the resonant state of the first and second target devices is found to the greatest extent, so that the prediction result is more precise. That is to say, the solution of the present disclosure provides a specific way to obtain the resonance-related information through the precise frequency sweep, which has high simulation efficiency, occupies fewer computing resources, has the more precise prediction result, and also has certain robustness to simulation errors.

In a specific example of the solution of the present disclosure, it may also be determined whether the found resonant state is accurate in the following way; specifically, a bare mode frequency of the second target device is obtained through simulation; and further, the above-mentioned step of obtaining the target coupling strength between the first and second target devices based on the first normal mode frequency of the first target device and the resonance-related information, specifically includes: when the difference between the bare mode frequency of the second target device and the target resonance frequency satisfies a preset condition, the target resonance frequency is considered to be a resonance frequency that satisfies the preset condition, or the target resonance frequency is the real resonance frequency, and at this time, the target coupling strength between the first and second target devices is obtained based on the first normal mode frequency of the first target device, and the resonance coupling strength and the target resonance frequency contained in the resonance-related information. For example, the target coupling strength between the first and second target devices is obtained based on the following formula (6).

Here, the preset condition is that the frequency interval between the bare mode frequency of the second target device and the target resonance frequency is less than or equal to a preset threshold. At this time, it is considered that the two target devices (that is, the first target device and the second target device) are in the resonant state; otherwise, that is, in the case where the frequency interval between the bare mode frequency of the second target device and the target resonance frequency is greater than the preset threshold, it is considered that the two target devices (that is, the first target device and the second target device) are not in the resonant state. In practical applications, the preset threshold is an empirical value, such as 1 MHz, which is not limited in the solution of the present disclosure.

Thus, the solution of the present disclosure improves the simulation precision while improving the simulation efficiency, so that the prediction result of the coupling strength between devices (for example, the first target device and the second target device) in the quantum chip layout is more precise.

In a specific example of the solution of the present disclosure, the bare mode frequency of the second target device may be obtained through simulation in the following way; that is, the above-mentioned step of obtaining the bare mode frequency of the second target device through simulation, specifically includes: adjusting a target parameter of the first target device to decouple the first target device from the second target device; and obtaining the bare mode frequency of the second target device through simulation after the decoupling is completed. Thus, a simple and feasible way to obtain the bare mode frequency is provided, to thereby lay the foundation for effectively improving the simulation precision and improving the accuracy of the simulation result.

In a specific example of the solution of the present disclosure, when the difference between the bare mode frequency of the second target device and the target resonance frequency does not satisfy the preset condition, the second preset step-size is reduced to re-determine a new target resonance frequency, until the bare mode frequency of the second target device and the new target resonance frequency satisfy the preset condition.

For example, if the frequency interval between the bare mode frequency of the second target device and the target resonance frequency is greater than the preset threshold, it is considered that the two target devices (that is, the first target device and the second target device) is not in the resonant state, and at this time, the resonant state between the first and second target devices is re-found, until the frequency interval between the bare mode frequency of the second target device and the new target resonance frequency satisfies the preset condition, for example, is less than or equal to the preset threshold, thus laying the foundation for effectively improving the simulation precision and improving the accuracy of the simulation result.

The solution of the present disclosure will be further described in detail below with specific examples; and specifically, the solution of the present disclosure proposes a method based on resonance frequency sweep, to precisely and efficiently determine the coupling strength between two target devices in the quantum chip (such as superconducting quantum chip) in simulation. Compared with the methods in the industry, the solution of the present disclosure is more precise and efficient in predicting the coupling strength between target devices, and is applicable to devices that are complex and difficult to precisely model. Further, the solution of the present disclosure has important guiding significance for the design, simulation and verification of the coupling strength between target devices in a quantum chip (such as superconducting quantum chip).

The solution of the present disclosure will be described in detail below from three aspects, specifically: the part I introduces the background knowledge of quantum chips (such as superconducting quantum chips) and clarifies the problems that the solution of the present disclosure aims to solve; and introduces the general modeling of the coupling strength of two target devices; the part II discusses the core method and steps of determining the coupling strength between target devices proposed in the solution of the present disclosure; and the part III gives a specific example to illustrate the detailed implementation steps of determining the coupling strength between target devices, and gives a numerical result to demonstrate the efficiency and accuracy of the solution of the present disclosure.

### Part I

In this part, the superconducting quantum chip is taken as an example, to perform the general modeling of the coupling strength between target devices in the superconducting quantum chip.

It can be understood that the following modeling process is also general, and for example, is also applicable to other quantum chips, which is not specifically limited in the solution of the present disclosure.

The superconducting quantum chip is the experimental carrier of superconducting quantum computing, and the design, simulation and verification thereof will have a direct impact on the final effect of the quantum algorithm and application. How to precisely and efficiently determine the coupling strength between target devices in the superconducting quantum chip layout becomes very important. Here, the devices in the superconducting quantum chip include, but are not limited to, qubit, coupler, read resonant cavity, filter, read transmission line, control line, and the like. It should be noted that at least one of two target devices of which the coupling strength is to be confirmed in the solution of the present disclosure needs to be adjustable in frequency. For example, when the superconducting quantum chip layout is determined, the qubit and coupler are usually devices with adjustable frequency, and the frequencies of other devices are not adjustable. Based on this, the coupling strengths between the qubit or coupler and other devices in the superconducting quantum chip layout can be obtained by the method described in the solution of the present disclosure.

Taking any two coupled target devices in the superconducting quantum chip as an example, the two target devices have their own inherent bare frequencies (also called bare mode frequencies) and the coupling interaction between the target devices. The quantum system formed by the two target devices is modeled to obtain the Hamiltonian H of the quantum system:

H=ω₁â₁^{†}â₁+ω₂â₂^{†}â₂+g(â₁^{†}+â₁)(â₂^{†}+â₂) Formula (1).

ω₁ represents the bare frequency of the first target device in the absence of coupling between the two target devices; ω₂ represents the bare frequency of the second target device in the absence of coupling between the two target devices; â₁ is the annihilation operator corresponding to the first target device; â₂ is the annihilation operator corresponding to the second target device; and g represents the coupling strength between the two target devices. It should be noted that the coupling strength g=g(ω₁, ω₂), which itself is a function of the bare frequencies (such as ω₁ and ω₂) corresponding to the two target devices.

Further, the Hamiltonian H in the formula (1) is diagonalized, to obtain the normal mode frequencies of the two target devices in the presence of coupling interaction, and further, to obtain the equivalent Hamiltonian \tilde{H} of the quantum system:

\tilde{H}=\tilde{ω}₁â₁^{†}â₁+\tilde{ω}₂â₂^{†}â₂ Formula (2).

\tilde{ω}₁ is the equivalent normal mode frequency (that is, the first normal mode frequency mentioned above) of the first target device in the presence of coupling between the two target devices; and \tilde{ω}₁ is the equivalent normal mode frequency of the second target device in the presence of coupling between the two target devices.

Here, the equivalent normal mode frequency \tilde{ω}₁ of the first target device is a function of the coupling strength g between the two target devices and the bare frequency ω₁ of the first target device in the absence of coupling between the two target devices. Correspondingly, the equivalent normal mode frequency \tilde{ω}₂ of the second target device is a function of the coupling strength g between the two target devices and the bare frequency ω₂ of the second target device in the absence of coupling between the two target devices.

Based on this, the bare frequencies (such as ω₁ and ω₂) and the equivalent normal mode frequencies (such as \tilde{ω}₁ and \tilde{ω}₂) of the two target devices may be obtained by the electromagnetic simulation method, and then the coupling strength g between the two target devices is obtained by the inverse solution.

It should be noted that the above method is strict without approximation, but the equivalent normal mode frequency or bare frequency obtained by simulation has a certain error in the actual electromagnetic simulation, so the coupling strength g obtained by calculation will be very sensitive to the error of the electromagnetic simulation, and eventually the precision of the obtained coupling strength g will be greatly reduced.

In view of the above reason, the solution of the present disclosure provides a method based on electromagnetic simulation to obtain the coupling strength between target devices efficiently and precisely.

In general, the coupling strength between two target devices is much less than the bare frequency of each target device, that is, g<<ω₁ or ω₂. Based on this, the solution of the present disclosure considers that, when two target devices resonate, the bare frequencies (such as ω₁ and ω₂) of the target devices are equal to the resonance frequency (that is, the target resonance frequency) ω₀ in the resonant state, that is, ω₁=ω₂=ω₀. At this time, the equivalent normal mode frequencies corresponding to the two target devices may be approximated as:

\tilde{ω}₁=ω₀+g₀, \tilde{ω}₂=ω₀−g₀ Formula (3).

g₀=g(ω₀) is the coupling strength when the two target devices resonate, that is, the resonance coupling strength.

Further, the conversion between g and g₀ is:

$$g = {g}_{0} * \frac{\sqrt{{ω}_{1} * {ω}_{2}}}{{ω}_{0}} . \qquad Formula ( 4 )$$

Further, if the frequency of one of the two target devices is adjustable (for example, one of the target devices is a qubit with adjustable frequency, or a coupler with adjustable frequency, etc.), then the frequency of the target device with adjustable frequency may be adjusted by adjusting the equivalent inductance of the target device with adjustable frequency, thereby making the two target devices reach the resonant state.

In the solution of the present disclosure, in order to judge whether the two target devices reach the resonant state, the equivalent inductance of the target device with adjustable frequency may be adjusted, and the electromagnetic simulation is performed to obtain the equivalent normal mode frequencies of the two target devices, and then the frequency difference (that is, the frequency interval) between the obtained normal mode frequencies of the two target devices is used to determine whether the two target devices reach the resonant state. Here, this adjustment process is called “frequency sweep” in the solution of the present disclosure.

Further, the frequency interval Δ≡|\tilde{ω}₁−\tilde{ω}₂| of the equivalent normal mode frequencies corresponding to the two target devices with the coupling effect is defined. When the two target devices reach the resonant state, the interval Δ of their corresponding equivalent normal mode frequencies reaches the minimum value Δₘᵢₙ.

Further, the minimum value Δₘᵢₙ and the resonance coupling strength g₀ have the following relationship:

Δₘᵢₙ=2g₀ Formula (5).

Therefore, firstly, the frequency sweep is performed on the target device with adjustable frequency, and the minimum frequency interval of the equivalent normal mode frequencies of the two target devices is obtained by observation, and at this time, it can be determined that the two target devices reach the resonant state; and secondly, the equivalent normal mode frequencies of the two target devices in the resonant state are obtained through electromagnetic simulation, and the interval between them is calculated to obtain the coupling strength g₀ in the resonant state.

Here, it is assumed that the frequency of the first target device is adjustable, and the frequency of the second target device is fixed; at this time, ω₁ is adjustable, and ω₂ remains unchanged; and then the general situation can be obtained from the formula (4), for example, the coupling strength g between the two target devices in the non-resonant state is:

$$g = {g}_{0} * \sqrt{\frac{{\tilde{ω}}_{1}}{{ω}_{0}}} . \qquad Formula ( 6 )$$

Here, g₀ is the coupling strength when the two target devices resonate, that is, the resonance coupling strength; \tilde{ω}₁ is the equivalent normal mode frequency of the first target device with adjustable frequency in the presence of coupling between the two target devices; and ω₀ is the resonance frequency when the two target devices are in the resonant state, that is, the target resonance frequency.

The solution of the present disclosure can obtain the coupling strength between the two target devices based on the formula (6).

### Part II

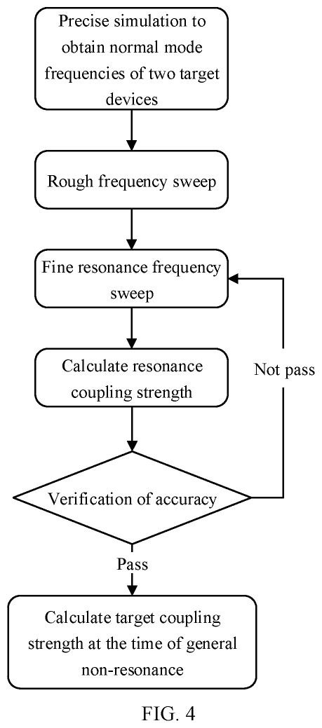

The calculation process of the coupling strength of two target devices in the superconducting quantum chip layout when the coupling type between the two target devices is non-resonant coupling will be illustrated below. As shown in FIG. 4, the specific steps are as follows.

Step 1: precise simulation to obtain the equivalent normal mode frequencies of two target devices.

Specifically, for two target devices (generally non-resonant) of which the coupling strength needs to be determined in the superconducting quantum chip layout, the high-precision electromagnetic simulation is performed to obtain the equivalent normal mode frequency \tilde{ω}₁ (that is, the first normal mode frequency mentioned above) of the first target device and the equivalent normal mode frequency \tilde{ω}₂ of the second target device.

Here, the first target device is a device with adjustable frequency, such as a qubit or a coupler; and the second target device is a device with adjustable or non-adjustable frequency. It should be noted that, when the second target device is a device with adjustable frequency, the frequency of the second target device is also a fixed value in this example. In other words, in this example, only the frequency of the first target device is adjusted, that is, frequency sweep, while the frequency of the second target device is not adjusted.

Step 2: rough frequency sweep to obtain the corresponding frequency range when the two target devices reach the resonant state, that is, the target resonance range.

Specifically, for the target device with adjustable frequency, i.e., the first target device, the equivalent inductance of the first target device is adjusted with a slightly larger step-size (i.e., the first preset step-size, for example, which is an inductance step-size of 0.5 nH−1 nH), to thereby achieve the purpose of adjusting the frequency of the first target device, so that the normal mode frequencies of the two target devices are as close as possible; and further, the electromagnetic simulation is performed after each adjustment to obtain the equivalent normal mode frequencies of the two target devices, to thereby find the frequency range in which the two target devices reach the resonant state, that is, the target frequency range.

Step 3: fine resonance frequency sweep within the target resonance range to obtain the target resonance frequency ω₀ when the two target devices are in the resonant state.

Specifically, the finer resonance frequency sweep is performed on the target resonance range determined in step 2. At the same time, the simulation precision is improved and the equivalent inductance step-size in the frequency sweep is shortened (for example, shortened to 0.05 nH−0.1 nH), that is, the frequency sweep is performed with a second preset step-size smaller than the first preset step-size within the target resonance range, to obtain the equivalent normal mode frequencies of the two target devices near the resonance point (or resonance frequency point, that is, the above-mentioned target resonance frequency), and thus obtain a smooth frequency sweep curve. Further, the minimum frequency interval between two normal mode frequencies is found in the frequency sweep curve, and the minimum frequency interval corresponds to the resonance frequency point of the two target devices, that is, the above-mentioned target resonance frequency ω₀ . Here, the average frequency of the two normal mode frequencies corresponding to the minimum frequency interval is the target resonance frequency ω₀.

Step 4: calculate the resonance coupling strength.

Specifically, the normal mode frequencies corresponding to the two target devices at the resonance frequency point in step 3 are obtained, and the minimum frequency interval Δₘᵢₙ is calculated, thereby obtaining the resonance coupling strength g₀=Δₘᵢₙ/2 of the two target devices in the resonant state.

Step 5: verification of accuracy.

Specifically, the inductance value of the equivalent inductance of the first target device with adjustable frequency is adjusted and adjusted to a large value (for example, 100-500 nH), so that the two target devices are decoupled; and the high-precision electromagnetic simulation is performed on the second target device, to obtain the bare frequency \tilde{ω} of the second target device.

If the absolute value of the frequency difference between the bare frequency \tilde{ω} of the second target device and the target resonance frequency ω₀ obtained in step 3 is greater than a preset threshold (such as 1 MHz), then it indicates that the true resonance frequency point is not found. At this time, the process returns to step 3, to further shorten the equivalent inductance step-size in the frequency sweep, that is, reduce the second preset step-size, and perform the fine resonance frequency sweep, until the frequency difference corresponding to the newly obtained target resonance frequency ω₀ is less than or equal to the preset threshold. Otherwise, step 6 is performed.

Step 6: calculate the target coupling strength at the time of general non-resonance. Specifically, the target coupling strength g between the two target devices at the time of non-resonance is obtained using the formula (6).

### Part III

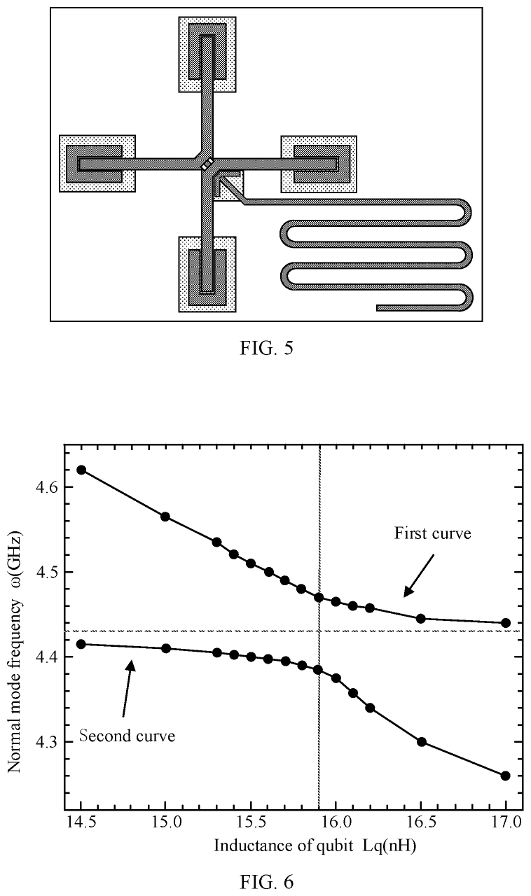

In order to test the effect of the solution of the present disclosure, the coupling strength between a qubit with adjustable frequency and a read resonant cavity with non-adjustable frequency is taken as an example for illustration. Specifically, FIG. 5 is a schematic diagram of a quantum chip layout including a qubit and a read resonant cavity, where the cross-shaped structure on the left is the qubit, and the curved structure on the right is the read resonant cavity. The specific process includes the followings.

Step 1: perform the electromagnetic simulation on the qubit and the read resonant cavity in the quantum chip layout shown in FIG. 1, to obtain the normal mode frequency \tilde{ω}₁ of the qubit in the case of non-resonance and the normal mode frequency \tilde{ω}₂ of the read resonant cavity in the case of non-resonance, where the normal mode frequency of the qubit in the case of non-resonance is \tilde{ω}₁=6.674 GHz, and the normal mode frequency of the read resonant cavity in the case of non-resonance is \tilde{ω}₂=4.428 GHz.

Step 2: adjust the frequency value of the qubit by adjusting the inductance value L_{q} of the equivalent inductance of the qubit, and perform the rough frequency sweep to obtain a rough resonance frequency range (that is, the target resonance range mentioned above).

Specifically, as shown in FIG. 6, the first curve corresponds to the qubit, and the second curve corresponds to the read resonant cavity. The points on the first curve are the equivalent normal mode frequencies corresponding to the qubit obtained by simulation. Similarly, the points on the second curve are the equivalent normal mode frequencies corresponding to the read resonant cavity obtained by simulation. Further, taking the inductance range of the equivalent inductance as the target resonance range as an example, as shown in FIG. 6, the rough resonance frequency range, i.e., the target resonance range, is a range of 15.3-16.2 nH corresponding to the inductance value L_{q} of the equivalent inductance of the qubit in this example.

Step 3: perform the fine resonance frequency sweep in the range of 15.3-16.2 nH, and obtain a resonance frequency (that is, the target resonance frequency, corresponding to the horizontal dotted line in FIG. 6) ω₀=4.431 GHz (corresponding to the horizontal dotted line in FIG. 6).

Specifically, the fine frequency sweep is performed on the inductance value L_{q} of the equivalent inductance of the qubit in the range of 15.3-16.2 nH, to find the minimum frequency interval of the normal mode frequencies of the qubit and the read resonant cavity. As shown in FIG. 6, it can be clearly seen that the frequency interval of the normal mode frequencies of the qubit and the read resonant cavity is minimum when the qubit is at the inductance L_{q}=15.9 nH, that is, the qubit and the read resonant cavity reach resonance at L_{q}=15.9 nH (corresponding to the vertical solid line in FIG. 6). Further, the average frequency of the two normal mode frequencies corresponding to the minimum frequency interval is calculated to obtain the target resonance frequency ω₀=4.431 GHz.

Step 4: calculate the resonance coupling strength.

Specifically, the minimum frequency interval of the two normal mode frequencies at L_{q}=15.9 nH is calculated as Δₘᵢₙ=101 MHz, so the resonance coupling strength g₀=50.5 MHz when the qubit resonates with the read resonant cavity can be obtained.

Step 5: verification of accuracy.

Specifically, the inductance of the qubit is adjusted to L_{q}=200 nH, so that the qubit is decoupled from the read resonant cavity; and further, the electromagnetic simulation is performed to obtain the bare frequency \tilde{ω}=4.431 GHz of the read resonant cavity. In the simulation precision, the bare frequency \tilde{ω} of the read resonant cavity is equal to the resonance frequency ω₀. The found target resonance frequency is the real resonance frequency point, and step 6 is performed.

Step 6: calculate the coupling strength at the time of general non-resonance. The target coupling strength g=g₀×\sqrt{\tilde{ω}₁/ω₀}=62.0 MHz between the qubit and the read resonant cavity at the time of non-resonance is obtained by solving the formula (6).

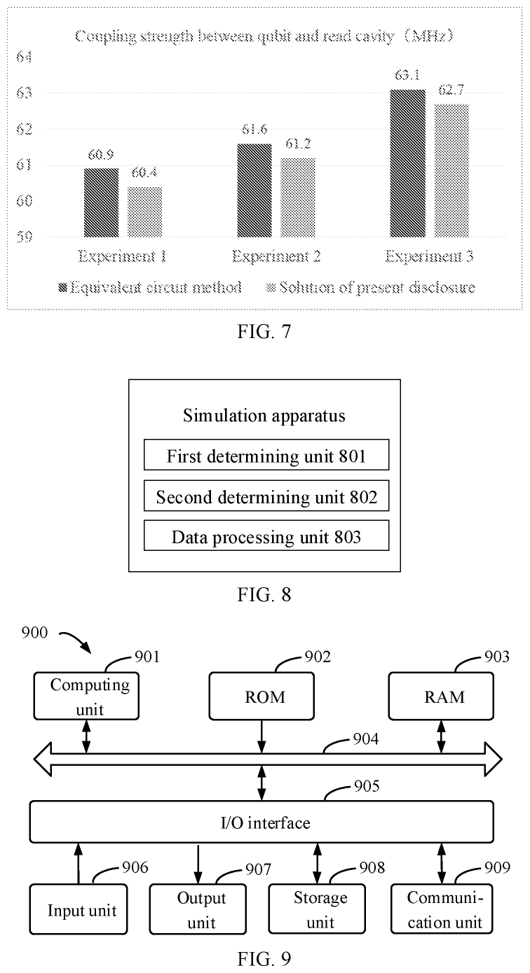

The target coupling strength between the qubit and the read resonant cavity can be efficiently obtained through the above steps. Here, in order to verify the correctness of the solution of the present disclosure, multiple groups of experiments are carried out on a variety of different superconducting quantum chip layouts including qubits and read resonant cavities, and the coupling strength between the qubit and the read resonant cavity is calculated using the solution of the present disclosure and the equivalent circuit method respectively. The comparison result is shown in FIG. 7. It can be seen from FIG. 7 that the prediction result obtained by the solution of the present disclosure is in good agreement with the prediction result obtained by the equivalent circuit.

It should be noted that, in addition to being able to accurately and efficiently determine the coupling strength between different target devices in a quantum chip layout (such as superconducting quantum chip layout), the solution of the present disclosure also has an advantage, that is, the obtained target coupling strength is not sensitive to the simulation error. Obviously, this is very helpful to improve the efficiency of simulation and verification of the quantum chip.

Specifically, assuming that the simulation error of the normal mode frequency of the target device obtained by simulation is δ to 1 MHz, then the error of the final coupling strength between two target devices obtained through the above steps is at most \sqrt{\tilde{ω}₁/ω₀}*δ˜1.3 MHz. However, if the coupling strength is calculated by the direct electromagnetic simulation method, the error of the result is estimated to be about 25 MHz based on the same simulation error. The above error comparison shows that the target coupling strength between target devices obtained by the solution of the present disclosure is robust to simulation error, and further shows that the solution of the present disclosure can obtain the coupling strength between two target devices more accurately.

In addition, it is worth noting that the solution of the present disclosure is also applicable to the typical determination of the coupling strength between a qubit and a coupler in a superconducting quantum chip. If the frequencies of both the qubit and the coupler are adjustable, any device may be selected as the device with adjustable frequency, and then the coupling strength between the qubit and the coupler is determined by using the “resonance sweep method” of the solution of the present disclosure.

In summary, the solution of the present disclosure can precisely and efficiently determine the coupling strength between devices in the superconducting quantum chip in simulation.

In summary, the solution of the present disclosure has the following advantages.
1. High efficiency. In the design stage of the quantum chip (or superconducting quantum chip), the solution of the present disclosure can conduct electromagnetic simulation on the layout of the quantum chip (or superconducting quantum chip) and use the resonance sweep method to obtain the coupling strength between two devices, and the required simulation overhead is relatively small. Therefore, the solution of the present disclosure greatly accelerates the process of the design, verification and iteration of the quantum chip (or superconducting quantum chip).
2. High precision. The solution of the present disclosure predicts the coupling strength between devices more precisely, and has certain robustness to electromagnetic simulation errors, improving the reliability of the solution of the present disclosure greatly.
3. Strong practicability. The solution of the present disclosure is applicable to devices in most quantum chips (or superconducting quantum chips). Moreover, for any complex device that is difficult to model, the solution of the present disclosure can treat it as a “black box” to obtain the coupling strength between two devices, so the application range is wide and the practicability is strong.

The solution of the present disclosure further provides a simulation apparatus, as shown in FIG. 8, including: a first determining unit 801 configured to obtain a first normal mode frequency of a first target device with adjustable frequency among at least two devices of a quantum chip layout through simulation; a second determining unit 802 configured to determine resonance-related information of the first target device and a second target device in a resonant state among the at least two devices; where the second target device is a device with adjustable or non-adjustable frequency among the at least two devices; and a data processing unit 803 configured to obtain a target coupling strength between the first and second target devices based on the first normal mode frequency of the first target device and the resonance-related information.

In a specific example of the solution of the present disclosure, the first normal mode frequency is a normal mode frequency of the first target device in a non-resonant state or resonant state.

In a specific example of the solution of the present disclosure, the second determining unit 802 is further configured to: adjust a frequency of the first target device with a first preset step-size, to obtain a plurality of second normal mode frequencies corresponding to the first target device and a plurality of third normal mode frequencies corresponding to the second target device through simulation; where the plurality of second normal mode frequencies are normal mode frequencies corresponding to the first target device in a case of the first target device is at a plurality of frequency values determined based on the first preset step-size, and the plurality of third normal mode frequencies are normal mode frequencies corresponding to the second target device in the case of the first target device is at the plurality of frequency values obtained based on the first preset step-size; obtain a target resonance range based on the plurality of second normal mode frequencies and the plurality of third normal mode frequencies; and determine the resonance-related information of the first and second target devices in the resonant state among the at least two devices based on the target resonance range.

In a specific example of the solution of the present disclosure, the second determining unit 802 is specifically configured to: adjust the frequency of the first target device with a second preset step-size in the target resonance range, to obtain a plurality of fourth normal mode frequencies corresponding to the first target device and a plurality of fifth normal mode frequencies corresponding to the second target device through simulation; where the plurality of fourth normal mode frequencies are normal mode frequencies corresponding to the first target device in a case of the first target device is at a plurality of frequency values determined based on the second preset step-size; the plurality of fifth normal mode frequencies are normal mode frequencies corresponding to the second target device in the case of the first target device is at the plurality of frequency values determined based on the second preset step-size; and the second preset step-size is smaller than the first preset step-size; and determine the resonance-related information of the first and second target devices in the resonant state among the at least two devices based on the plurality of fourth normal mode frequencies and the plurality of fifth normal mode frequencies.

In a specific example of the solution of the present disclosure, the second determining unit 802 is specifically configured to: adjust the frequency of the first target device by adjusting an equivalent inductance of the first target device.

In a specific example of the solution of the present disclosure, the second determining unit 802 is specifically configured to: obtain a target frequency interval based on frequency intervals between the fourth normal mode frequencies and the fifth normal mode frequencies corresponding to the frequency values; and obtain the resonance-related information of the first and second target devices in the resonant state containing a resonance coupling strength and/or a target resonance frequency, based on the target frequency interval.

In a specific example of the solution of the present disclosure, the second determining unit 802 is specifically configured to: obtain a minimum frequency interval based on a frequency interval between a fourth normal mode frequency and a corresponding fifth normal mode frequency corresponding to each frequency value; and take the minimum frequency interval as the target frequency interval.

In a specific example of the solution of the present disclosure, the first determining unit 801 is further configured to obtain a bare mode frequency of the second target device through simulation; and the data processing unit 803 is further configured to obtain the target coupling strength between the first and second target devices based on the first normal mode frequency of the first target device and the resonance coupling strength and the target resonance frequency contained in the resonance-related information, in a case of a difference between the bare mode frequency of the second target device and the target resonance frequency satisfies a preset condition.

In a specific example of the solution of the present disclosure, the first determining unit 801 is specifically configured to: adjust a target parameter of the first target device to decouple the first target device from the second target device; and obtain the bare mode frequency of the second target device through simulation after the decoupling is completed.

In a specific example of the solution of the present disclosure, the data processing unit 803 is further configured to: reduce the second preset step-size to determine a new target resonance frequency until the bare mode frequency of the second target device and the new target resonance frequency satisfy the preset condition, in a case of the difference between the bare mode frequency of the second target device and the target resonance frequency does not satisfy the preset condition.

For the description of specific functions and examples of the units of the apparatus of the embodiment of the present disclosure, reference may be made to the relevant description of the corresponding steps in the above-mentioned method embodiments, and details are not repeated here.

According to the embodiments of the present disclosure, the present disclosure also provides an electronic device, a readable storage medium and a computer program product.

FIG. 9 shows a schematic block diagram of an exemplary electronic device 900 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 9, the device 900 includes a computing unit 901 that may perform various appropriate actions and processes according to a computer program stored in a Read-Only Memory (ROM) 902 or a computer program loaded from a storage unit 908 into a Random Access Memory (RAM) 903. Various programs and data required for an operation of device 900 may also be stored in the RAM 903. The computing unit 901, the ROM 902 and the RAM 903 are connected to each other through a bus 904. The input/output (I/O) interface 905 is also connected to the bus 904.

A plurality of components in the device 900 are connected to the I/O interface 905, and include an input unit 906 such as a keyboard, a mouse, or the like; an output unit 907 such as various types of displays, speakers, or the like; the storage unit 908 such as a magnetic disk, an optical disk, or the like; and a communication unit 909 such as a network card, a modem, a wireless communication transceiver, or the like. The communication unit 909 allows the device 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 901 performs various methods and processing described above, such as the simulation method. For example, in some implementations, the simulation method may be implemented as a computer software program tangibly contained in a computer-readable medium, such as the storage unit 908. In some implementations, a part or all of the computer program may be loaded and/or installed on the device 900 via the ROM 902 and/or the communication unit 909. When the computer program is loaded into the RAM 903 and executed by the computing unit 901, one or more steps of the simulation method described above may be performed. Alternatively, in other implementations, the computing unit 901 may be configured to perform the simulation method by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A simulation method, comprising:
obtaining a first normal mode frequency of a first target device with adjustable frequency among at least two devices of a quantum chip layout through simulation;
determining resonance-related information of the first target device and a second target device in a resonant state among the at least two devices; wherein the second target device is a device with adjustable or non-adjustable frequency among the at least two devices; and
obtaining a target coupling strength between the first and second target devices based on the first normal mode frequency of the first target device and the resonance-related information.

2. The method of claim 1, wherein the first normal mode frequency is a normal mode frequency of the first target device in a non-resonant state or resonant state.

3. The method of claim 1, further comprising:
adjusting a frequency of the first target device with a first preset step-size, to obtain a plurality of second normal mode frequencies corresponding to the first target device and a plurality of third normal mode frequencies corresponding to the second target device through simulation; wherein the plurality of second normal mode frequencies are normal mode frequencies corresponding to the first target device in a case of the first target device is at a plurality of frequency values determined based on the first preset step-size, and the plurality of third normal mode frequencies are normal mode frequencies corresponding to the second target device in the case of the first target device is at the plurality of frequency values obtained based on the first preset step-size; and
obtaining a target resonance range based on the plurality of second normal mode frequencies and the plurality of third normal mode frequencies;
wherein determining the resonance-related information of the first and second target devices in the resonant state among the at least two devices, comprises:
determining the resonance-related information of the first and second target devices in the resonant state among the at least two devices based on the target resonance range.

4. The method of claim 2, further comprising:
adjusting a frequency of the first target device with a first preset step-size, to obtain a plurality of second normal mode frequencies corresponding to the first target device and a plurality of third normal mode frequencies corresponding to the second target device through simulation; wherein the plurality of second normal mode frequencies are normal mode frequencies corresponding to the first target device in a case of the first target device is at a plurality of frequency values determined based on the first preset step-size, and the plurality of third normal mode frequencies are normal mode frequencies corresponding to the second target device in the case of the first target device is at the plurality of frequency values obtained based on the first preset step-size; and
obtaining a target resonance range based on the plurality of second normal mode frequencies and the plurality of third normal mode frequencies;
wherein determining the resonance-related information of the first and second target devices in the resonant state among the at least two devices, comprises:
determining the resonance-related information of the first and second target devices in the resonant state among the at least two devices based on the target resonance range.

5. The method of claim 3, wherein determining the resonance-related information of the first and second target devices in the resonant state among the at least two devices based on the target resonance range, comprises:
adjusting the frequency of the first target device with a second preset step-size in the target resonance range, to obtain a plurality of fourth normal mode frequencies corresponding to the first target device and a plurality of fifth normal mode frequencies corresponding to the second target device through simulation; wherein the plurality of fourth normal mode frequencies are normal mode frequencies corresponding to the first target device in a case of the first target device is at a plurality of frequency values determined based on the second preset step-size; the plurality of fifth normal mode frequencies are normal mode frequencies corresponding to the second target device in the case of the first target device is at the plurality of frequency values determined based on the second preset step-size; and the second preset step-size is smaller than the first preset step-size; and
determining the resonance-related information of the first and second target devices in the resonant state among the at least two devices based on the plurality of fourth normal mode frequencies and the plurality of fifth normal mode frequencies.

6. The method of claim 4, wherein determining the resonance-related information of the first and second target devices in the resonant state among the at least two devices based on the target resonance range, comprises:
adjusting the frequency of the first target device with a second preset step-size in the target resonance range, to obtain a plurality of fourth normal mode frequencies corresponding to the first target device and a plurality of fifth normal mode frequencies corresponding to the second target device through simulation; wherein the plurality of fourth normal mode frequencies are normal mode frequencies corresponding to the first target device in a case of the first target device is at a plurality of frequency values determined based on the second preset step-size; the plurality of fifth normal mode frequencies are normal mode frequencies corresponding to the second target device in the case of the first target device is at the plurality of frequency values determined based on the second preset step-size; and the second preset step-size is smaller than the first preset step-size; and
determining the resonance-related information of the first and second target devices in the resonant state among the at least two devices based on the plurality of fourth normal mode frequencies and the plurality of fifth normal mode frequencies.

7. The method of claim 3, wherein adjusting the frequency of the first target device, comprises:
adjusting the frequency of the first target device by adjusting an equivalent inductance of the first target device.

8. The method of claim 4, wherein adjusting the frequency of the first target device, comprises:
adjusting the frequency of the first target device by adjusting an equivalent inductance of the first target device.

9. The method of claim 5, wherein adjusting the frequency of the first target device, comprises:
adjusting the frequency of the first target device by adjusting an equivalent inductance of the first target device.

10. The method of claim 6, wherein adjusting the frequency of the first target device, comprises:
adjusting the frequency of the first target device by adjusting an equivalent inductance of the first target device.

11. The method of claim 5, wherein determining the resonance-related information of the first and second target devices in the resonant state among the at least two devices based on the plurality of fourth normal mode frequencies and the plurality of fifth normal mode frequencies, comprises:
obtaining a target frequency interval based on frequency intervals between the plurality of fourth normal mode frequencies and the plurality of fifth normal mode frequencies corresponding to the plurality of frequency values; and
obtaining the resonance-related information of the first and second target devices in the resonant state containing a resonance coupling strength and/or a target resonance frequency, based on the target frequency interval.

12. The method of claim 6, wherein determining the resonance-related information of the first and second target devices in the resonant state among the at least two devices based on the plurality of fourth normal mode frequencies and the plurality of fifth normal mode frequencies, comprises:
obtaining a target frequency interval based on frequency intervals between the plurality of fourth normal mode frequencies and the plurality of fifth normal mode frequencies corresponding to the plurality of frequency values; and
obtaining the resonance-related information of the first and second target devices in the resonant state containing a resonance coupling strength and/or a target resonance frequency, based on the target frequency interval.

13. The method of claim 11, wherein obtaining the target frequency interval based on the frequency intervals between the plurality of fourth normal mode frequencies and the plurality of fifth normal mode frequencies corresponding to the plurality of frequency values, comprises:
obtaining a minimum frequency interval based on a frequency interval between a fourth normal mode frequency and a corresponding fifth normal mode frequency corresponding to each frequency value; and
taking the minimum frequency interval as the target frequency interval.

14. The method of claim 12, wherein obtaining the target frequency interval based on the frequency intervals between the plurality of fourth normal mode frequencies and the plurality of fifth normal mode frequencies corresponding to the plurality of frequency values, comprises:
obtaining a minimum frequency interval based on a frequency interval between a fourth normal mode frequency and a corresponding fifth normal mode frequency corresponding to each frequency value; and
taking the minimum frequency interval as the target frequency interval.

15. The method of claim 11, further comprising:
obtaining a bare mode frequency of the second target device through simulation;
wherein obtaining the target coupling strength between the first and second target devices based on the first normal mode frequency of the first target device and the resonance-related information, comprises:
obtaining the target coupling strength between the first and second target devices based on the first normal mode frequency of the first target device and the resonance coupling strength and the target resonance frequency contained in the resonance-related information, responsive to a difference between the bare mode frequency of the second target device and the target resonance frequency satisfying a preset condition.

16. The method of claim 15, wherein obtaining the bare mode frequency of the second target device through simulation, comprises:
adjusting a target parameter of the first target device to decouple the first target device from the second target device; and
obtaining the bare mode frequency of the second target device through simulation after decoupling is completed.

17. The method of claim 15, further comprising:
reducing the second preset step-size to determine a new target resonance frequency until the bare mode frequency of the second target device and the new target resonance frequency satisfy the preset condition, in a case of the difference between the bare mode frequency of the second target device and the target resonance frequency does not satisfy the preset condition.

18. An electronic device, comprising:
at least one processor; and
a memory in communication with the at least one processor;
wherein the memory stores an instruction that, when executed by the at least one processor, causes the at least one processor to execute operations, comprising:
obtaining a first normal mode frequency of a first target device with adjustable frequency among at least two devices of a quantum chip layout through simulation;
determining resonance-related information of the first target device and a second target device in a resonant state among the at least two devices; wherein the second target device is a device with adjustable or non-adjustable frequency among the at least two devices; and
obtaining a target coupling strength between the first and second target devices based on the first normal mode frequency of the first target device and the resonance-related information.

19. The electronic device of claim 18, wherein the first normal mode frequency is a normal mode frequency of the first target device in a non-resonant state or resonant state.

20. A non-transitory computer-readable storage medium storing a computer instruction thereon, wherein the computer instruction causes a computer to execute operations, comprising:
obtaining a first normal mode frequency of a first target device with adjustable frequency among at least two devices of a quantum chip layout through simulation;
determining resonance-related information of the first target device and a second target device in a resonant state among the at least two devices; wherein the second target device is a device with adjustable or non-adjustable frequency among the at least two devices; and
obtaining a target coupling strength between the first and second target devices based on the first normal mode frequency of the first target device and the resonance-related information.
